(19) United States
(12) Patent Application Publication
(10) Pub. No.: US 2025/0377553 A1
(43) Pub. Date: Dec. 11, 2025

(54) MODULAR ERGONOMIC GOGGLE

(71) Applicant: Apple Inc., Cupertino, CA (US)

(72) Inventors: Samuel O. Schneider, Sacramento, CA (US); John S. Camp, Los Gatos, CA (US); Daniel A. Henneh, San Jose, CA (US); Megan Grant, San Francisco, CA (US); John A. Porcella, Campbell, CA (US); Michael E. Savery, San Francisco, CA (US)

(21) Appl. No.: 18/977,537

(22) Filed: Dec. 11, 2024

Related U.S. Application Data
(60) Provisional application No. 63/658,613, filed on Jun. 11, 2024.

(51) Int. Cl. G02C 3/00; G02B 27/01; G02C 5/12

(52) U.S. Cl. CPC G02C 3/003; G02B 27/0176; G02C 5/122

(57) ABSTRACT

A head mountable display (HMD) can include a display unit, a facial engagement that can be selectively coupled to the display unit, and a securement that can be selectively coupled to the display unit. The facial engagement can be configured to engage a face of a user, such as to fit the HMD to the user's face. The securement can be configured to position the facial engagement against the user's face, such as to position the display unit for viewing by the user. A first coupling can removably couple the facial engagement to the display unit for modularity. A second coupling can removably couple the securement to the display unit for modularity. The display unit, a first facial engagement, a second facial engagement, a first securement, and a second securement can be mixed and matched to configure the HMD based on user preference, form factor, or use.

### CROSS-REFERENCE TO RELATED APPLICATION

This application claims the benefit of U.S. Provisional Patent Application No. 63/658,613, filed 11 Jun. 2024, and entitled “MODULAR ERGONOMIC GOGGLE,” the entire disclosure of which is hereby incorporated by reference.

### FIELD

The present disclosure relates generally to head mountable computer systems that provide computer-generated experiences, including, but not limited to, electronic devices that provide virtual reality and mixed reality experiences via a display.

### BACKGROUND

The development of computer systems for augmented reality, including head mountable computer systems, has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Various examples of the present disclosure include a head mountable display (HMD). The HMD can include a display unit. The display unit can include mounting structures. The HMD can include a front cover configured to be selectively coupled to the display unit. The HMD can include a facial engagement configured to be selectively coupled to the display unit. The facial engagement can be configured to engage a face of a user. The HMD can include a securement configured to be selectively coupled to the mounting structures. The securement can be configured to position the facial engagement against the face of the user. A combination of the front cover and the facial engagement can retain the mounting structures.

In one example, the securement can include a strap, a band, or a pair of arms configured to secure the HMD to the user's head. In one example, the facial engagement can include a facial pad. The facial pad can be configured to primarily engage a brow of the user. In one example, the facial engagement can include a light seal configured to limit light ingress when sealed against the face of the user. In one example, the front cover can be selectively coupled to a frame of the display unit. In one example, the HMD can include an adjustable nose pad. In one example, a modular system can include the HMD. The facial engagement can be a first facial engagement. The system can include a second facial engagement configured to removably couple to the display unit. The first facial engagement or the second facial engagement can be configured to be selectively coupled to the display unit. In one example, a modular system can include the HMD. The securement can be a first securement. The system can include a second securement configured to removably couple to the display unit. The first securement or the second securement can be configured to be selectively coupled to the display unit. The second securement can be of a different type than the first securement.

Various examples of the present disclosure include an HMD. The HMD can include a display unit. The HMD can include a facial engagement removably coupled to the display unit and configured to fit the HMD to the user's face. The HMD can include multiple different securements each configured to removably couple to the display unit to adjust the HMD to respective form factors or uses.

In one example, the securement can include an attachment rig configured to cantilever the display unit in front of the user. In one example, the securement can include a band selected from a plurality of bands based on user preference or use. In one example, the facial engagement can include a facial pad selected from a plurality of facial pads based on user preference or use. In one example, a modular system can include the HMD. The facial engagement can be a first facial engagement. The multiple different securements can include a first securement and a second securement of a different type than the first securement. The system can include a second facial engagement configured to removably couple to the display unit. The second facial engagement can be of a different type than the first facial engagement. The display unit, the first facial engagement, the second facial engagement, the first securement, and the second securement can be configured to be mixed and matched to vary the HMD based on a user preference.

Various examples of the present disclosure include an electronic display device. The electronic display device can include a display unit. The electronic display device can include a facial engagement configured to engage a face of a user. The electronic display device can include multiple different securements each configured to secure the electronic display device to the user's head to change a form factor or use of the electronic display device. The electronic display device can include a first coupling to removably couple the facial engagement to the display unit. The electronic display device can include a second coupling to removably couple the securement to the display unit.

In one example, the electronic display device can include an adjustment configured to fit the electronic display device to the user. The adjustment can include an adjustable nose pad. In one example, a system can include the electronic display device. The facial engagement can be a first facial engagement. The multiple securements can include a first securement and a second securement. The system can include a second facial engagement. The first coupling can be configured to selectively couple the first facial engagement or the second facial engagement to the display unit. The second coupling can be configured to selectively couple the first securement or the second securement to the display unit. The first facial engagement can include a light seal. The second facial engagement can include a brow pad. The first securement can include a first one of a strap, a band, or a pair of arms. The second securement can include a second one of the strap, band, or pair of arms.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an exploded view of an example HMD;

FIG. 2 illustrates an example HMD;

FIG. 3 illustrates another example HMD; and

FIG. 4 illustrates another example HMD.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to an HMD with user swappable ergo elements that can be mixed and matched to wear the system as a goggle, glasses, or a hybrid system depending on user preference. The swappable elements can include a facial pad or other facial engagement, arms, straps, or a headband, among other elements described herein. For example, different securements (e.g., bands, arms, straps, etc.) can be swapped out for different scenarios, preferences, or style (e.g., activities, user size, hair styles, vision, modes, etc.), or to customize the HMD for use or use case (e.g., bigger screen or display for certain uses, smaller screen or display for normal use, outside environments, school use, theme park use, single use cases, durability, etc.), such as to adjust the HMD to respective form factors or uses. In some examples, the modularity can accommodate one or more add-on modules, such as to enhance function and/or use of the HMD. The modular elements can be provided by a third-party, such as to allow industry support and customization. The modularity can also allow system compatibility with later generations of products, such as to mix and match components from different product generations, etc.

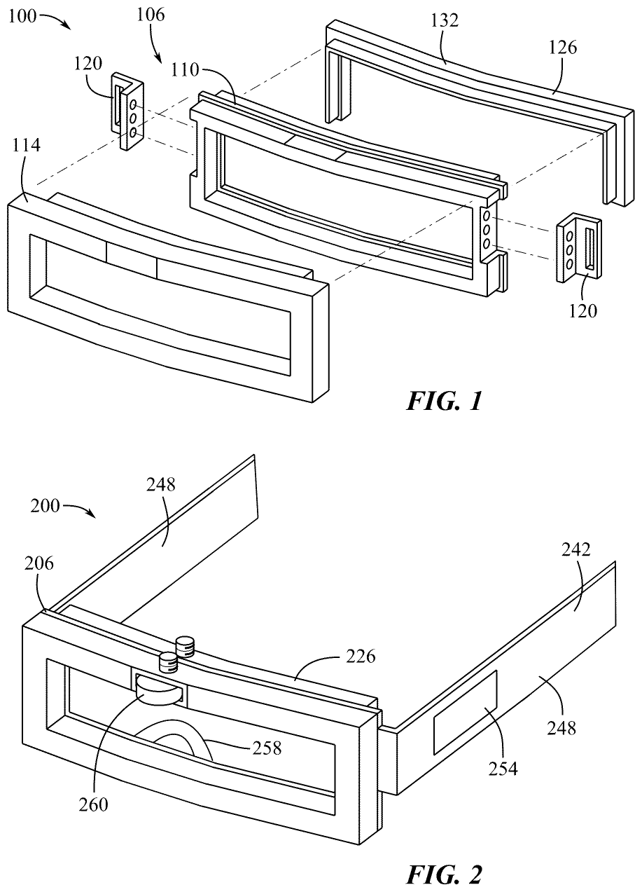

These and other embodiments are discussed below with reference to FIGS. 1-4. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates an exploded view of an example head mountable display (HMD) 100 or electronic display device, including various portions or parts thereof separated according to modularity and selective coupling of those parts, as described herein. The HMD 100 can be configured to be donned by a user, such as to provide virtual and altered, mixed, or augmented reality (VR/AR) experiences. For example, a user can wear the HMD 100 to view content, visualize an environment with VR/AR, capture point of view (POV) images or video, or the like. The HMD 100 can be lightweight and/or have a small form factor, such that the HMD 100 is comfortable to wear (e.g., for long periods of time), easy to manipulate or deal with, feels natural, etc. In some examples, the HMD 100 can include one or more features to enhance comfort, such as securements, bands, engagements, pads, supports, and the like, as more fully described below.

The HMD 100 can include a display unit 106 or assembly. The display unit 106 can be configured to display content (e.g., to the wearer or user of the HMD 100). For example, the display unit 106 can include a display screen, such as disposed to project images towards the user (e.g., a rear-facing display screen). In some examples, the display screen can be distributed across multiple displays, such as first and second displays for the left and right eyes of the user. The displays or display screen unit can be supported by a frame 110 or housing, such as part of a display assembly coupled to the frame 110.

The display unit 106 can include a front cover 114. The front cover 114 can be coupled (e.g., selectively coupled) to the frame 110 (e.g., to a first or front side of the frame 110). In some examples, the front cover 114 can include or define a front display assembly. For example, the front cover 114 can be configured to display images outwardly, such as to conceal or obscure portions of the display unit 106 behind the front cover 114 (e.g., sensors, the displays or display screen, the frame 110, etc.) for desired aesthetics. The front cover 114 can provide a protection for the display unit 106, such as providing a protective shell, dust and water ingress protection, etc. In some examples, the front cover 114 can be interchangeable, such as to allow replacement of the front cover 114 when damaged, to provide a different look, for modularity, etc. The coupling can allow selective removal of the front cover 114 from the display unit 106, such as for modularity or to allow disposable use of the front cover 114. For example, the front cover 114 can be disposable for sharing the display unit 106 with multiple users (e.g., one display unit 106 with personal or tailored front covers 114 for each user that can be swapped between users). In some examples, the coupling can be defined by magnets, removable fasteners, a sliding retention, interference fit, corresponding retention features, etc.

In some examples, the display unit 106 can include a processor, a sensor assembly, circuitry, a cooling assembly, motors, lens, etc., or any combination thereof, disposed within or supported by the frame 110. In some examples, the frame 110 can accommodate glasses, filters, viewfinders, optical modules, or the like. In some examples, the display unit 106 can include mounting structures 120 or architecture configured to secure the display unit 106 (e.g., on the wearer or user). The mounting structures 120 can be coupled to or formed on the frame 110, such as to or on outboard edges or ends of the frame 110 (e.g., lateral side edges of the frame 110). In such examples, the front cover 114 can protect and/or conceal/hide the mounting structures 120. In other examples, the front cover 114 can define at least a portion of the mounting structures 120. In some examples, coupling the front cover 114 to the frame 110 can secure the mounting structures 120 in place. In some examples, the front cover 114 can be coupled to the mounting structures 120. The display unit 106 (e.g., the frame 110, front cover 114, etc.) can be curved to compliment the user's facial features and general curvature from one side of the face to the other (e.g., from left to right and/or from top to bottom).

The HMD 100 can include a facial engagement 126. The facial engagement 126 can be configured to engage a face of the user or wearer, such as to fit the HMD 100 to the user's face. For example, the facial engagement 126 can include a facial pad 132. The facial pad 132 can be flexible to conform to the user's face, such as including padding or other compliant material. In some examples, the facial engagement 126 (e.g., facial pad 132) can engage the brow, cheeks, and nose, or any combination or portions thereof. In some examples, the facial engagement 126 (e.g., facial pad 132) can engage only select portions of the user's face. For instance, the facial pad 132 can be limited to engage the brow of the user (e.g., a brow only pad), such as to enable peripheral vision while wearing the HMD 100. In some examples, the facial engagement 126 can include a light seal. The light seal can be configured to limit light ingress when sealed against the user's face, such as to create an environment suitable to view images and content displayed by the display unit 106.

The facial engagement 126 can be selectively coupled to the display unit 106. For example, the facial engagement 126 can be selectively coupled to the frame 110 (e.g., to a second or rear side of the frame 110). In some examples, the facial engagement 126 can be interchangeable, such as to allow replacement of the facial engagement 126 when damaged, to provide different facial engagements 126 (e.g., full light seal vs. brow pad), to adjust the HMD 100 to the user's face (e.g., size and shape) or to a different user, for modularity, etc. The coupling can allow selective removal of the facial engagement 126 from the display unit 106, such as for modularity or to allow disposable use of the facial engagement 126. For example, the facial engagement 126 can be disposable for sharing the display unit 106 with multiple users (e.g., one display unit 106 with personal or tailored fit facial engagements 126 for each user that can be swapped between users). In some examples, the coupling can be defined by magnets, removable fasteners, a sliding retention, interference fit, corresponding retention features, etc.

In some examples, one facial engagement 126 can be removed and replaced with another facial engagement 126 for modularity. In this manner, one facial engagement 126 can be a first facial engagement, and another facial engagement 126 can be a second facial engagement. In such examples, the user can selectively couple the first facial engagement or the second facial engagement to the display unit 106 based on user preference and modularity of use. In some examples, the second facial engagement can be of a different type than the first facial engagement (e.g., brow pad vs. light seal).

In some examples, the HMD 100 can include a first coupling to removably couple the facial engagement 126 to the display unit 106 for modularity. For example, the HMD 100, the first facial engagement, and the second facial engagement can form a modular system. In such examples, the display unit 106, the first facial engagement, and the second facial engagement can be mixed and matched to configure the HMD 100 based on user preference. For instance, the first coupling can be configured to selectively couple the first facial engagement or the second facial engagement to the display unit 106. In some examples, the facial engagement 126 can include a facial pad 132 selected from a plurality of facial pads based on user preference or use, adding further modularity to the system.

In some examples, a combination of the front cover 114 and the facial engagement 126 can retain the mounting structures 120. For example, at least a portion of the front cover 114 and/or the facial engagement 126 (e.g., only the front cover 114, only the facial engagement 126, or both the front cover 114 and the facial engagement 126) can extend over all or a portion of the mounting structures 120, such as to limit removal of the mounting structures 120 when the front cover 114 and/or the facial engagement 126 is coupled to the display unit 106. In some examples, the mounting structures 120 can be sandwiched or otherwise positioned between the front cover 114 and the facial engagement 126, such as at least partially between the front cover 114 and the facial engagement 126, between the front cover 114, facial engagement 126 and frame 110, or the like.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

FIG. 2 illustrates an example HMD 200. The HMD 200 can be similar to the HMD 100 of FIG. 1, described above. For example, the HMD 200 can include a display unit 206 and a facial engagement 226, similar to those described above. The description of these and other like features (as indicated with like reference numbers) is incorporated herein with reference to FIG. 2. The HMD 200 can include a securement 242 selectively or removably coupled to the display unit 206 (e.g., to the mounting structures 220). The securement 242 can be configured to position the facial engagement 226 against the user's face, such as to position the display unit 206 for viewing by the user (e.g., to adjust the HMD 200 to a first form factor or use). For example, the securement 242 can engage the user to hold the display unit 206 in viewing position (e.g., to align the display unit 206 with the user's eyes), with the facial engagement 226 in position on the user's face. In this manner, the securement 242 can form or define a retention assembly configured to hold the display unit 206 or HMD 200 in position on the user.

In the example of FIG. 2, the securement 242 includes a pair of arms 248 configured to secure the HMD 200 to the user's head. The arms 248 can be similar to eyeglass or sunglass arms or temples. For example, the arms 248 can extend from the display unit 206 to engage the user at the temples, above the ears, behind the ears, or any combination thereof, such as the arms 248 wrapping at least partially around and behind the ears. Donning the HMD 200 can tension the arms 248 against the side of the user's head to hold the HMD 200 in position. In some examples, the arms 248 can include a friction material or grip to limit movement of the HMD 200 when donned, such as a non-slip material at the tips of the arms 248.

In some examples, each arm 248 or at least one arm 248 can include an electronic component 254. The electronic component 254 can include a microphone configured to detect sound, such as the user's speech. The electronic component 254 can include a speaker configured to emit sounds. The electronic component 254 can be operably connected to a controller for processing of detected sounds and control of sound levels and other sound characteristics.

The arms 248 can be selectively coupled to the frame 210, the mounting structures 220, or any combination thereof. In some examples, the arms 248 can be interchangeable, such as to allow replacement of the arms 248 when damaged, to provide different arms 248 based on user preference, form factor, or use (e.g., active vs. leisure; tight vs. loose, etc.), to adjust the HMD 200 to the user's head (e.g., adjust for size and shape) or to a different user, for modularity, etc. The coupling can allow selective removal of the arms 248 from the display unit 206, such as for modularity or to allow disposable use of the arms 248. For example, the arms 248 can be disposable for sharing the display unit 206 with multiple users (e.g., one display unit 206 with personal or tailored fit arms 248 for each user that can be swapped between users). In some examples, the coupling can be defined by magnets, removable fasteners, a sliding retention, interference fit, corresponding retention features, etc.

In some examples, the HMD 200 can include an adjustment to fit the HMD 200 to the user. For example, the HMD 200 can include an adjustable nose pad 258 to fit or position the HMD 200 to the user's face. The nose pad 258 can be adjusted up or down (e.g., towards or away from the top of the display unit 206, a height of the nose pad 258, etc.), such as via a dial 260, to adjust the HMD 200 to the user. In some examples, the depth of the nose pad 258 can also be adjusted, such as via the same dial 260 or a different dial. In some examples, the dial 260 can adjust other features of the HMD 200 to fit the HMD 200 to the user. In some examples, nose pad 258 can be releasably held in a desired position (e.g., via a detent structure, friction, or the like), so as to limit undesired adjustment or loss of an adjusted setting.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

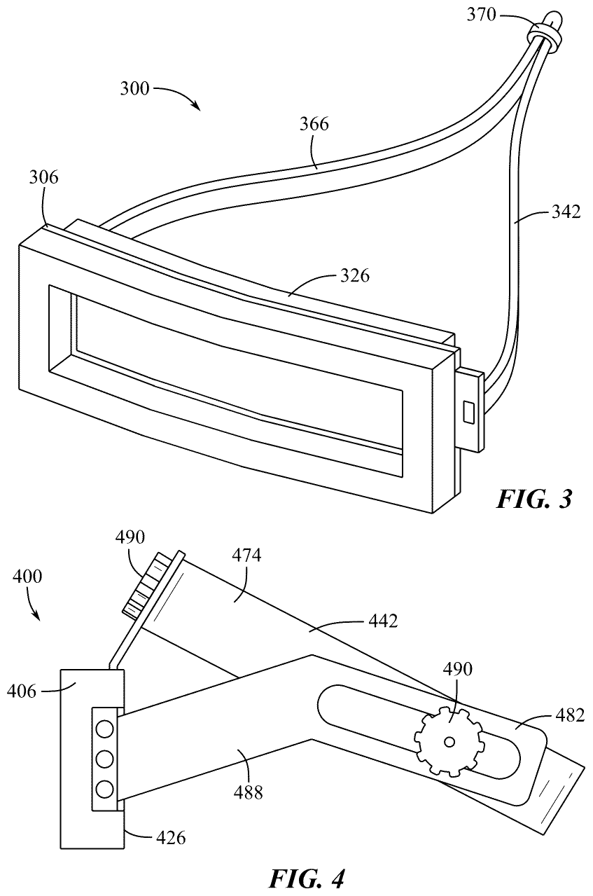

FIG. 3 illustrates another example HMD 300. The HMD 300 can be similar to the HMD 100 of FIG. 1 and/or the HMD 200 of FIG. 2, described above. For example, the HMD 300 can include any combination of a display unit 306, a facial engagement 326, and a securement 342, similar to those described above. The description of these and other like features (as indicated with like reference numbers) is incorporated herein with reference to FIG. 3. In the example of FIG. 3, the securement 342 includes a strap 366 or band configured to secure the HMD 300 to the user's head (e.g., to adjust the HMD 300 to a second form factor or use). The strap 366 can extend from the display unit 306 and around the user's head (e.g., to wrap around the rear side of the user's head). The strap 366 can be flexible and resiliently deformable (e.g., stretch) to conform to the user's head. In some examples, the tension of the strap 366 can be adjusted. For instance, a strap lock 370 (e.g., similar to a cord lock) can selectively engage or lock along the length of the strap 366 to adjust the strap 366 to the user's head (e.g., moved towards the display unit 306 to fit the HMD 300 to smaller head sizes, moved away from the display unit 306 to fit the HMD 300 to larger head sizes) In some examples, the strap lock 370 can be moved along the strap's length to tension the strap 366 as needed for use (e.g., towards the display unit 306 for increased tension for high user activity or movement, away from the display unit 306 for decreased tension for low user activity or movement).

The strap 366 can be selectively coupled to the display unit 306. For example, the strap 366 can be selectively coupled to the frame 310, the mounting structures 320, or any combination thereof. As a result, the mounting structures 320 can switch or accommodate a different securement 342, such as for a different form factor or use. In some examples, the strap 366 can be interchangeable, such as to allow replacement of the strap 366 when damaged, to provide a different strap 366 based on user preference, form factor, or use (e.g., active vs. leisure; tight vs. loose; hair style; etc.), to adjust the HMD 300 to the user's head (e.g., adjust for size and shape) or to a different user, for modularity, etc. The coupling can allow selective removal of the strap 366 from the display unit 306, such as for modularity or to allow disposable use of the strap 366. For example, the strap 366 can be disposable for sharing the display unit 306 with multiple users (e.g., one display unit 306 with personal or tailored fit straps 366 for each user that can be swapped between users). In some examples, the coupling can be defined by magnets, removable fasteners, a sliding retention, interference fit, corresponding retention features, etc.

In some examples, the strap 366 can be removed and replaced with the arms 248 for modularity. In this manner, the arms 248 can be a first securement, and the strap 366 can be a second securement. In such examples, the user can selectively couple the first securement (e.g., arms 248) or the second securement (e.g., strap 366) to the display unit 306 based on user preference and modularity of use. In some examples, the second securement can be of a different type than the first securement (e.g., strap vs. arms).

In some examples, the HMD 300 can include a second coupling (e.g., the mounting structures 320) to removably couple the securement 342 to the display unit 306 for modularity. For example, the HMD 300, the first securement, and the second securement can form a modular system. In such examples, the display unit 306, the first securement, and the second securement can be mixed and matched to configure the HMD 300 based on user preference. For instance, the second coupling can be configured to selectively couple the first securement or the second securement to the display unit 306. In some examples, the securement 342 can include a band selected from a plurality of bands based on user preference or use, adding further modularity to the system.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

FIG. 4 illustrates another example HMD 400. The HMD 400 can be similar to the HMD 100 of FIG. 1, the HMD 200 of FIG. 2, and/or the HMD 300 of FIG. 3, described above. For example, the HMD 400 can include any combination of a display unit 406, a facial engagement 426, and a securement 442, similar to those described above. The description of these and other like features (as indicated with like reference numbers) is incorporated herein with reference to FIG. 4. In the example of FIG. 4, the securement 442 includes a headband 474 configured to secure the HMD 400 to the user's head (e.g., to adjust the HMD 400 to a third form factor or use). The headband 474 can extend from the display unit 406 and around the user's head (e.g., to wrap around the rear side of the user's head). The headband 474 can be flexible and resiliently deformable (e.g., stretch) to conform to the user's head. In some examples, the tension of the headband 474 can be adjusted. For instance, a buckle or clip can selectively engage or lock along the length of the headband 474 to adjust the headband 474 to the user's head and/or tension the headband 474 as needed for use (e.g., to fit the headband 474 to smaller head sizes, fit the headband 474 to larger head sizes, for increased tension for high user activity or movement, for decreased tension for low user activity or movement, etc.).

In some examples, the headband 474 can be part of an attachment rig 482. The attachment rig 482 can be configured to cantilever the display unit 406 in front of the user. For example, the attachment rig 482 can include a pair of support arms 488 extending from the headband 474 for coupling to the display unit 406. The orientation and/or position of the support arms 488 can be adjusted to fit the HMD 400 to the user, such as to position the display unit 406 for proper viewing. For example, the support arms 488 can be adjusted to move the display unit 406 up or down, or towards or away from the user's face, such as via one or more dials 490.

The attachment rig 482 can be selectively coupled to the display unit 406. For example, the attachment rig 482 can be selectively coupled to the frame 410, the mounting structures 420, or any combination thereof. As a result, the mounting structures 420 can switch or accommodate a different securement 442. In some examples, the attachment rig 482 can be interchangeable, such as to allow replacement of the attachment rig 482 when damaged, to provide a different attachment rig 482 or securement 442 based on user preference or use, to adjust the HMD 400 to the user's head (e.g., adjust for size and shape) or to a different user, for modularity, etc. The coupling can allow selective removal of the attachment rig 482 from the display unit 406, such as for modularity or to allow disposable use of the attachment rig 482. For example, the attachment rig 482 can be disposable for sharing the display unit 406 with multiple users (e.g., one display unit 406 with personal or tailored fit attachment rigs 482 for each user that can be swapped between users). In some examples, the coupling can be defined by magnets, removable fasteners, a sliding retention, interference fit, corresponding retention features, etc.

In some examples, the attachment rig 482 can be removed and replaced with a different securement 442 for modularity. In this manner, the user can selectively couple a first securement (e.g., a first one of a strap, a band, or a pair of arms) or a second securement (e.g., a second one of the strap, band, or pair of arms) to the display unit 406 based on user preference and modularity of use. In some examples, the HMD 400, the first securement, the second securement, a first facial engagement, and a second facial engagement can form a modular system. In such examples, the display unit 406, the first facial engagement, the second facial engagement, the first securement, and the second securement can be mixed and matched to configure the HMD 400 based on user preference.

The various securements described herein are exemplary only, and the HMD 400 can include other securement types. For example, the securement 442 can include a tripod, a grip, or a stick, among other securement types. Along these lines, the modularity of the HMD 400 can accommodate one or more add-on modules to be selectively or removably coupled thereto. For example, lighting, waterproofing, and other modules can be coupled to the HMD 400 in a modular fashion. One or more of the modular components can be third-party options or interfaces. For example, the display unit 406 can accommodate facial engagements 426 or securements 442 provided by one or more third-parties.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

To the extent applicable to the present technology, gathering and use of data available from various sources can be used to improve the delivery to users of invitational content or any other content that can be of interest to them. The present disclosure contemplates that in some instances, this gathered data can include personal information data that uniquely identifies or can be used to contact or locate a specific person. Such personal information data can include demographic data, location-based data, telephone numbers, email addresses, X® (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data can be used to provide insights into a user's general wellness, or can be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A head mountable display (HMD) comprising:
a display unit comprising mounting structures;
a front cover configured to be selectively coupled to the display unit;
a facial engagement configured to be selectively coupled to the display unit, the facial engagement configured to engage a face of a user; and
a securement configured to be selectively coupled to the mounting structures, and to position the facial engagement against the face of the user, wherein a combination of the front cover and the facial engagement retains the mounting structure.

2. The HMD of claim 1, wherein the securement comprises a strap, a band, or a pair of arms configured to secure the HMD to the user's head.

3. The HMD of claim 1, wherein the facial engagement comprises a facial pad.

4. The HMD of claim 3, wherein the facial pad is configured to primarily engage a brow of the user.

5. The HMD of claim 1, wherein the facial engagement comprises a light seal configured to limit light ingress when sealed against the face of the user.

6. The HMD of claim 1, wherein the front cover is selectively coupled to a frame of the display unit.

7. The HMD of claim 1, further comprising an adjustable nose pad.

8. A modular system comprising the HMD of claim 1, wherein:
the facial engagement is a first facial engagement;
the system further comprises a second facial engagement configured to removably couple to the display unit; and
the first facial engagement or the second facial engagement configured to be selectively coupled to the display unit.

9. A modular system comprising the HMD of claim 1, wherein:
the securement is a first securement;
the system further comprises a second securement configured to removably couple to the display unit; and
the first securement or the second securement configured to be selectively coupled to the display unit.

10. The system of claim 9, wherein the second securement is of a different type than the first securement.

11. A head mountable display (HMD) comprising:
a display unit;
a facial engagement removably coupled to the display unit and configured to fit the HMD to the user's face;
a first securement configured to removably couple to the display unit and provide the HMD in a first form factor or use; and
a second securement, different from the first securement, configured to removably couple to the display unit and provide the HMD in a second form factor or use.

12. The HMD of claim 11, wherein the securement comprises an attachment rig configured to cantilever the display unit in front of the user.

13. The HMD of claim 11, wherein the securement comprises a band selected from a plurality of bands based on user preference or use.

14. The HMD of claim 11, wherein the facial engagement comprises a facial pad selected from a plurality of facial pads based on user preference or use.

15. A modular system comprising the HMD of claim 11, wherein:
the facial engagement is a first facial engagement;
the system further comprises a second facial engagement configured to removably couple to the display unit, the second facial engagement of a different type than the first facial engagement; and
the display unit, the first facial engagement, the second facial engagement, the first securement, and the second securement are configured to be mixed and matched to vary the HMD.

16. An electronic display device comprising:
a display unit;
a facial engagement configured to engage a face of a user;
a first securement and a second securement, each of the first securement and the second securement configured to secure the electronic display device to the user's head to set a form factor or a use of the electronic display device, the first securement and the second securement each setting a different form factor or use of the electronic display device;
a first coupling to removably couple the facial engagement to the display unit; and
a second coupling to removably couple the first securement and the second securement to the display unit.

17. The electronic display device of claim 16, further comprising an adjustment configured to fit the electronic display device to the user.

18. The electronic display device of claim 17, wherein the adjustment comprises an adjustable nose pad.

19. A system comprising the electronic display device of claim 16, wherein:
the facial engagement is a first facial engagement;
the system further comprises a second facial engagement;
the first coupling is configured to selectively couple the first facial engagement or the second facial engagement to the display unit; and
the second coupling is configured to selectively couple the first securement or the second securement to the display unit.

20. The system of claim 19, wherein:
the first facial engagement comprises a light seal;
the second facial engagement comprises a brow pad;
the first securement comprises a first one of a strap, a band, or a pair of arms; and
the second securement comprises a second one of the strap, band, or pair of arms.
